(19) United States
(12) Patent Application Publication
(10) Pub. No.: US 2022/0405879 A1
(43) Pub. Date: Dec. 22, 2022

(54) METHOD FOR PROCESSING IMAGES AND ELECTRONIC DEVICE

(71) Applicant: BEIJING DAJIA INTERNET INFORMATION TECHNOLOGY CO., LTD., Beijing (CN)

(72) Inventor: Xin YAN, Beijing (CN)

(21) Appl. No.: 17/822,493

(22) Filed: Aug. 26, 2022

Related U.S. Application Data
(63) Continuation of application No. PCT/CN2020/129503, filed on Nov. 17, 2020.

(30) Foreign Application Priority Data
Apr. 30, 2020 (CN) 202010364388.9

(51) Int. Cl. G06T 3/00; G06V 40/16; G06T 3/40; G06T 5/50; G06T 7/246; G06T 7/73

(52) U.S. Cl. CPC G06T 3/0093; G06V 40/171; G06T 3/40; G06T 5/50; G06T 7/246; G06T 7/73; G06T 2207/30201

(57) ABSTRACT

A method for processing images includes: determining a plurality of first key points in a first image; determining a target region of the first image, wherein the target region is acquired by expanding a region corresponding to the plurality of first key points; and acquiring a second image by adjusting a target part based on the region corresponding to the plurality of first key points and the target region.

### CROSS-REFERENCE TO RELATED APPLICATION

This application is a continuation application of International Application No. PCT/CN2020/129503, filed on Nov. 17, 2020, which claims priority to Chinese Patent Application No. 202010364388.9, filed on Apr. 30, 2020, the disclosures of which are herein incorporated by reference in their entireties.

### TECHNICAL FIELD

The present disclosure relates to the field of computer technologies, and in particular, to a method for processing images and an electronic device.

### BACKGROUND

At present, users' needs for beauty of faces in shot images are increasing. For example, some users desire larger eyes, thinner eyebrows, higher nose bridges, and the like in the faces. Therefore, it is necessary to perform image processing on the shot images, such that the faces in the images can meet the users' needs.

### SUMMARY

Embodiments of the present disclosure provide a method for processing images and an electronic device, which can optimize image processing effects. The technical solutions are as follows.

According to one aspect of the embodiments of the present disclosure, a method for processing images is provided. The method includes: determining a plurality of first key points in a first image, wherein the plurality of first key points are key points of a target part; determining a target region of the first image by expanding a region corresponding to the plurality of first key points; and acquiring a second image by adjusting positions of pixel points in a first partial image and a second partial image based on a center point of the region corresponding to the plurality of first key points and a first adjustment parameter, the first partial image being an image corresponding to the region corresponding to the plurality of first key points, and the second partial image being an image other than the first partial image in the target region.

In some embodiments, acquiring the second image includes: adjusting a shape of the first partial image based on the center point of the region corresponding to the plurality of first key points and the first adjustment parameter; and dispersing the pixel points in the second partial image to acquire the second image.

In some embodiments, dispersing the pixel points in the second partial image to acquire the second image includes: determining a first movement direction in response to the first partial image being zoomed out, wherein the first movement direction is a direction approaching the center point; determining a first movement distance based on the first adjustment parameter, and acquiring the second image by moving the pixel points in the second partial image by the first movement distance in the first movement direction.

In some embodiments, dispersing the pixel points in the second partial image to acquire the second image includes: determining a second movement direction in response to the first partial image being zoomed in, wherein the second movement direction is a direction going away from the center point; determining a second movement distance based on the first adjustment parameter, and acquiring the second image by moving the pixel points in the second partial image by the second movement distance in the second movement direction.

In some embodiments, determining the target region of the first image includes: determining a target center point, wherein the target center point is acquired based on the plurality of first key points; determining, for each first key point, a second key point, wherein the second key point, the first key point, and the target center point are on one straight line, and a first distance is greater than a second distance, the first distance being a distance between the second key point and the target center point, and the second distance being a distance between the first key point and the target center point; and determining the target region based on a plurality of second key points.

In some embodiments, determining the target center point includes any one of: determining a center point of the plurality of first key points as the target center point; and determining a center point of a part of the first key points as the target center point, wherein the part of first key points are disposed in a center zone of the region corresponding to the plurality of first key points.

In some embodiments, determining the plurality of first key points in the first image includes: determining a plurality of third key points in a third image, wherein the plurality of third key points are key points of the target part, and the third image is a previous frame of the first image; determining a plurality of fourth key points in the first image, wherein the plurality of fourth key points are key points of the target part, and the fourth key points are determined by a key point determination model; and determining the plurality of first key points based on the plurality of third key points and the plurality of fourth key points.

In some embodiments, determining the plurality of first key points includes: determining, for each fourth key point, a first target key point in the plurality of third key points, wherein the first target key point and the fourth key point have an equal pixel value; determining an average position of a first position and a second position, wherein the first position is a position of the first target key point, and the second position is a position of the fourth key point; and acquiring the first key point by rendering the pixel value of the fourth key point to the average position.

In some embodiments, determining the plurality of first key points includes any one of: determining, in response to the target part being occluded, a second target key point in the plurality of third key points, wherein the second target key point is a key point corresponding to the occluded target part; and acquiring the plurality of first key points, wherein the plurality of first key points are formed based on the second target key point and the plurality of fourth key points; and taking, in response to the target part being occluded, the plurality of third key points as the plurality of first key points.

In some embodiments, the method further includes: determining a second adjustment parameter in response to the target part being occluded, wherein the second adjustment parameter is a parameter for adjusting the third image; and acquiring the first adjustment parameter by adjusting the second adjustment parameter based on a predetermined amplitude.

In some embodiments, the method further includes: determining a number of consecutive frames of an image with the target part being occluded; and stopping image processing of a next frame image in response to the number reaching a target value.

According to another aspect of the embodiments of the present disclosure, an apparatus for processing images is provided. The apparatus includes: a first determining module, configured to determine a plurality of first key points in a first image, wherein the plurality of first key points are key points of a target part; a second determining module, configured to determine a target region of the first image by expanding a region corresponding to the plurality of first key points; and an image acquiring module, configured to acquire a second image by adjusting positions of pixel points in a first partial image and a second partial image based on a center point of the region corresponding to the plurality of first key points and a first adjustment parameter, the first partial image being an image corresponding to the region corresponding to the plurality of first key points, and the second partial image being an image other than the first partial image in the target region.

In some embodiments, the image acquiring module includes: a shape adjusting unit, configured to adjust a shape of the first partial image based on the center point of the region corresponding to the plurality of first key points and the first adjustment parameter; and a dispersing unit, configured to disperse the pixel points in the second partial image to acquire the second image.

In some embodiments, the dispersing unit is configured to determine a first movement direction in response to the first partial image being zoomed out, wherein the first movement direction is a direction approaching the center point; determine a first movement distance based on the first adjustment parameter, and determine the second image by moving the pixel points in the second partial image by the first movement distance in the first movement direction.

In some embodiments, the dispersing unit is configured to determine a second movement direction in response to the first partial image being zoomed in, wherein the second movement direction is a direction going away from the center point; determine a second movement distance based on the first adjustment parameter, and acquire the second image by moving the pixel points in the second partial image by the second movement distance in the second movement direction.

In some embodiments, the second determining module includes: a first determining unit, configured to determine a target center point, wherein the target center point is acquired based on the plurality of first key points; a second determining unit, configured to determine, for each first key point, a second key point, wherein the second key point, the first key point, and the target center point are on one straight line, and a first distance is greater than a second distance, the first distance being a distance between the second key point and the target center point, and the second distance being a distance between the first key point and the target center point; and a third determining unit, configured to determine the target region based on a plurality of second key points.

In some embodiments, the first determining unit is configured to determine a center point of the plurality of first key points as the target center point; and the first determining unit is configured to determine a center point of a part of the first key points as the target center point, wherein the part of first key points are disposed in a center zone of the region corresponding to the plurality of first key points.

In some embodiments, the first determining module includes: a fourth determining unit, configured to determine a plurality of third key points in a third image, wherein the plurality of third key points are key points of the target part, and the third image is a previous frame of the first image; a fifth determining unit, configured to determine a plurality of fourth key points in the first image, wherein the plurality of fourth key points are key points of the target part, and the fourth key points are determined by a key point determination model; and a sixth determining unit, configured to determine the plurality of first key points based on the plurality of third key points and the plurality of fourth key points.

In some embodiments, the sixth determining unit is configured to determine, for each fourth key point, a first target key point in the plurality of third key points, wherein the first target key point and the fourth key point have an equal pixel value; determine an average position of a first position and a second position, wherein the first position is a position of the first target key point, and the second position is a position of the fourth key point; and acquire the first key point by rendering the pixel value of the fourth key point to the average position.

In some embodiments, the sixth determining unit is configured to determine, in response to the target part being occluded, a second target key point in the plurality of third key points, wherein the second target key point is a key point corresponding to the occluded target part; and acquire the plurality of first key points, wherein the plurality of first key points are formed based on the second target key point and the plurality of fourth key points; and the sixth determining unit is configured to take, in response to the target part being occluded, the plurality of third key points as the plurality of first key points.

In some embodiments, the apparatus further includes: a third determining module, configured to determine a second adjustment parameter in response to the target part being occluded, wherein the second adjustment parameter is a parameter for adjusting the third image; and a fourth determining module, configured to acquire the first adjustment parameter by adjusting the second adjustment parameter based on a predetermined amplitude.

In some embodiments, the apparatus further includes: a fifth determining module, configured to determine a number of consecutive frames of an image with the target part being occluded; and an image processing module, configured to stop image processing of a next frame image in response to the number reaching a target value.

According to another aspect of the embodiments of the present disclosure, an electronic device is provided. The electronic device includes: one or more processors, and a transitory or non-transitory memory configured to store instructions executable by the one or more processors; wherein the one or more processors are configured to perform: determining a plurality of first key points in a first image, wherein the plurality of first key points are key points of a target part; determining a target region of the first image by expanding a region corresponding to the plurality of first key points; and acquiring a second image by adjusting positions of pixel points in a first partial image and a second partial image based on a center point of the region corresponding to the plurality of first key points and a first adjustment parameter, the first partial image being an image corresponding to the region corresponding to the plurality of first key points, and the second partial image being an image other than the first partial image in the target region.

In some embodiments, the one or more processors are configured to perform: adjusting a shape of the first partial image based on the center point of the region corresponding to the plurality of first key points and the first adjustment parameter; and dispersing the pixel points in the second partial image to acquire the second image.

In some embodiments, the one or more processors are configured to perform: determining a first movement direction in response to the first partial image being zoomed out, the first movement direction is a direction approaching the center point; determining a first movement distance based on the first adjustment parameter; and acquiring the second image by moving the pixel points in the second partial image by the first movement distance in the first movement direction.

In some embodiments, the one or more processors are configured to perform: determining a second movement direction in response to the first partial image being zoomed in, wherein the second movement direction is a direction going away from the center point; determining a second movement distance based on the first adjustment parameter, and acquiring the second image by moving the pixel points in the second partial image by the second movement distance in the second movement direction.

In some embodiments, the one or more processors are configured to perform: determining a target center point, wherein the target center point is acquired based on the plurality of first key points; determining, for each first key point, a second key point, wherein the second key point, the first key point, and the target center point are on one straight line, and a first distance is greater than a second distance, the first distance being a distance between the second key point and the target center point, and the second distance being a distance between the first key point and the target center point; and determining the target region based on a plurality of second key points.

In some embodiments, the one or more processors are configured to perform at least one of: determining a center point of the plurality of first key points as the target center point; and determining a center point of a part of the first key points as the target center point, wherein the part of first key points are disposed in a center zone of the region corresponding to the plurality of first key points.

In some embodiments, the one or more processors are configured to perform: determining a plurality of third key points in a third image, wherein the plurality of third key points are key points of the target part, and the third image is a previous frame of the first image; determining a plurality of fourth key points in the first image, wherein the plurality of fourth key points are key points of the target part, and the fourth key points are determined by a key point determination model; and determining the plurality of first key points based on the plurality of third key points and the plurality of fourth key points.

In some embodiments, the one or more processors are configured to perform: determining, for each fourth key point, a first target key point in the plurality of third key points, wherein the first target key point and the fourth key point have an equal pixel value; determining an average position of a first position and a second position, wherein the first position is a position of the first target key point, and the second position is a position of the fourth key point; and acquiring the first key point by rendering the pixel value of the fourth key point to the average position.

In some embodiments, the one or more processors are configured to perform at least one of: determining, in response to the target part being occluded, a second target key point in the plurality of third key points, wherein the second target key point is a key point corresponding to the occluded target part; and acquiring the plurality of first key points, wherein the plurality of first key points are formed based on the second target key point and the plurality of fourth key points; and taking, in response to the target part being occluded, the plurality of third key points as the plurality of first key points.

In some embodiments, the one or more processors are configured to perform: determining a second adjustment parameter in response to the target part being occluded, wherein the second adjustment parameter is a parameter for adjusting the third image; and acquiring the first adjustment parameter by adjusting the second adjustment parameter based on a predetermined amplitude.

In some embodiments, the one or more processors are configured to perform: determining a number of consecutive frames of an image with the target part being occluded; and stopping image processing of a next frame image in response to the number reaching a target value.

According to another aspect of the embodiments of the present disclosure, a computer-readable storage medium is provided. The computer-readable storage medium stores instructions therein, wherein the instructions, when executed by a processor of an electronic device, cause the electronic device to perform: determining a plurality of first key points in a first image, wherein the plurality of first key points are key points of a target part; determining a target region of the first image by expanding a region corresponding to the plurality of first key points; and acquiring a second image by adjusting positions of pixel points in a first partial image and a second partial image based on a center point of the region corresponding to the plurality of first key points and a first adjustment parameter, the first partial image being an image corresponding to the region corresponding to the plurality of first key points, and the second partial image being an image other than the first partial image in the target region.

According to another aspect of the embodiments of the present disclosure, a computer program product is provided. Instructions in the computer program product, when executed by a processor of an electronic device, cause the electronic device to perform: determining a plurality of first key points in a first image, wherein the plurality of first key points are key points of a target part; determining a target region of the first image by expanding a region corresponding to the plurality of first key points; and acquiring a second image by adjusting positions of pixel points in a first partial image and a second partial image based on a center point of the region corresponding to the plurality of first key points and a first adjustment parameter, the first partial image being an image corresponding to the region corresponding to the plurality of first key points, and the second partial image being an image other than the first partial image in the target region.

In the embodiments of the present disclosure, the target region is acquired by expanding the region where the target part is disposed in the first image, such that a change of the target part in the adjusted second image can gradually affect other regions in the first image, which prevents image distortion caused by an influence on the pixel points in other regions in the image when the target part is adjusted, and the image processing effects are optimized.

It should be understood that both the foregoing general description and the following detailed description are only exemplary and explanatory, and do not limit the scope of the present disclosure.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and those skills in the art can still derive other drawings from these accompanying drawings without creative efforts.

FIG. 1 is a schematic diagram of a method for processing images according to an exemplary embodiment of the present disclosure;

FIG. 2 is a block diagram of a terminal according to an exemplary embodiment of the present disclosure;

FIG. 3 is a block diagram of a server according to an exemplary embodiment of the present disclosure;

FIG. 4 is a block diagram of an apparatus for processing images according to an exemplary embodiment of the present disclosure;

FIG. 5 is a flowchart of a method for processing images according to an exemplary embodiment of the present disclosure;

FIG. 6 is a flowchart of a method for processing images according to an exemplary embodiment of the present disclosure;

FIG. 7 is a schematic diagram of key points of a facial region according to an exemplary embodiment of the present disclosure; and

FIG. 8 is a schematic diagram of a target region according to an exemplary embodiment of the present disclosure.

### DETAILED DESCRIPTION

To make those skilled in the art better understand the technical solutions of the present disclosure, the technical solutions in the embodiments of the present disclosure will be clearly and completely described below in combination with the accompanying drawings.

It should be noted that the terms “first,” “second,” and the like in the description and claims of the present disclosure and the above drawings are configured to distinguish similar objects, without necessarily describing a specific order or sequence. It should be understood that the data used in such a way can be interchanged under appropriate circumstances, such that the embodiments of the present disclosure described herein can be implemented in sequences other than those illustrated or described herein. The implementations described in the exemplary embodiments below are not intended to represent all implementations consistent with the present disclosure. In contrast, they are merely examples of the apparatuses and methods consistent with some aspects of the present disclosure as detailed in the appended claims.

User information involved in the present disclosure is the information authorized by users or fully authorized by all parties.

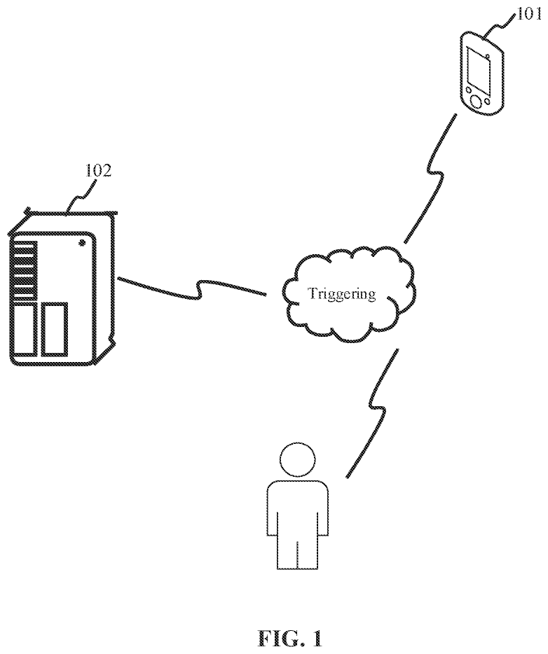

The present disclosure provides a method for processing images. An electronic device completes image processing on a first image by adjusting a target part in the first image. Referring to FIG. 1, an implementation environment of the embodiment of the present disclosure includes a user and an electronic device 101, 102. The user triggers image processing operation, the electronic device receives the image processing operation, and performs image processing on a first image according to the image processing operation.

The first image is a shot static image or an image in a video stream, which is not specifically limited in the embodiment of the present disclosure. In response to the first image being an image in the video stream, the electronic device determines the first image from the video stream. The video stream is a video stream corresponding to a long video or a video stream corresponding to a short video.

In response to the first image being the static image, the electronic device needs to capture the static image at first, or the electronic device receives the static image sent by other electronic devices. In some embodiments, the electronic device has an image acquisition function. Accordingly, the electronic device captures the static image. The process of capturing the static image by the electronic device is that the electronic device displays the shot image in a viewfinder, and in response to receiving a confirmation operation from the user, the electronic device determines that an image in the viewfinder is the first image based on the confirmation operation. In some embodiments, the electronic device receives the static image sent by other electronic devices, and determines the received first image as the static image. The process of capturing the static image by other electronic devices is similar to the process of capturing the static image by the electronic device, and details are not repeated here.

In response to the first image being an image in the video stream, the electronic device needs to capture the video stream at first, or the electronic device receives the video stream sent by other electronic devices. In some embodiments, the electronic device has an image acquisition function. Accordingly, the electronic device receives a shooting start instruction input by the user, and starts to capture the video stream. In response to receiving a shooting end instruction input by the user, the video stream is stopped from being captured, the video stream between the shooting start instruction and the shooting end instruction is determined, and any frame image is determined from the video stream as the first image. In some embodiments, the electronic device receives the video stream sent by other electronic devices, and determines the first image from the received video stream. The process of capturing the video stream by other electronic devices is similar to the process of capturing the video stream by the electronic device, and details are not repeated here.

In addition, in the process of capturing the first image, the electronic device performs image processing on the first image, and directly outputs a second image after the image processing. Alternatively, the electronic device firstly captures the first image and outputs the first image; in response to receiving an image processing instruction, the electronic device performs image processing on the first image to acquire the second image, which is not specifically limited in the embodiment of the present disclosure.

In some embodiments, the image processing instruction carries the target part of the current image processing and a first adjustment parameter, and the electronic device determines the target part of the current image processing and the first adjustment parameter based on the image processing instruction. In some embodiments, the electronic device sets the target part of the image processing and the first adjustment parameter in advance, and directly performs, in response to receiving an image adjustment instruction, image processing on the first image based on the target part and the first adjustment parameter.

In some embodiments, the target part is facial features in a facial region or a facial contour, for example, the target part is eyes, eyebrows, a nose bridge, a mouth, cheeks, or the like. Alternatively, the target part is other body parts, such as a waist and legs.

In some embodiments, the electronic device is a terminal, for example, the electronic device is a camera, a mobile phone, a tablet computer, a wearable device, or the like. An image processing application is installed in the terminal, and image processing is performed by the image processing application. The image processing application is a camera application, a beauty camera application, a video shooting application, and the like. In the embodiment illustrated in FIG. 1, a terminal 101 is illustrated.

In some embodiments, the electronic device is a server for image processing. Accordingly, the electronic device receives a to-be-processed first image sent by other electronic devices, performs image processing on the first image to acquire a second image, and returns the acquired second image to other electronic devices. The server is a single server, a server cluster composed of a plurality of servers, a cloud server, or the like. In the embodiment illustrated in FIG. 1, a server 102 is illustrated.

In an exemplary embodiment, an electronic device is further provided. The electronic device includes: one or more processors, and

a transitory or non-transitory memory configured to store instructions executable by the one or more processors;

wherein the one or more processors are configured to perform:

determining a plurality of first key points in a first image, wherein the plurality of first key points are key points of a target part;

determining a target region of the first image by expanding a region corresponding to the plurality of first key points; and

acquiring a second image by adjusting positions of pixel points in a first partial image and a second partial image based on a center point of the region corresponding to the plurality of first key points and a first adjustment parameter, the first partial image being an image corresponding to the region corresponding to the plurality of first key points, and the second partial image being an image other than the first partial image in the target region.

In some embodiments, the one or more processors are configured to perform:

adjusting a shape of the first partial image based on the center point of the region corresponding to the plurality of first key points and the first adjustment parameter; and

dispersing the pixel points in the second partial image to acquire the second image.

In some embodiments, the one or more processors are configured to perform:

determining a first movement direction in response to the first partial image being zoomed out, wherein the first movement direction is a direction approaching the center point;

determining a first movement distance based on the first adjustment parameter, and

acquiring the second image by moving the pixel points in the second partial image by the first movement distance in the first movement direction.

In some embodiments, the one or more processors are configured to:

determining a second movement direction in response to the first partial image being zoomed in, wherein the second movement direction is a direction going away from the center point;

determining a second movement distance based on the first adjustment parameter; and

acquiring the second image by moving the pixel points in the second partial image by the second movement distance in the second movement direction.

In some embodiments, the one or more processors are configured to perform:

determining a target center point, wherein the target center point is acquired based on the plurality of first key points;

determining, for each first key point, a second key point, wherein the second key point, the first key point, and the target center point are on one straight line, and a first distance is greater than a second distance, the first distance being a distance between the second key point and the target center point, and the second distance being a distance between the first key point and the target center point; and

determining the target region based on a plurality of second key points.

In some embodiments, the one or more processors are configured to perform at least one of:

determining a center point of the plurality of first key points as the target center point; and

determining a center point of a part of the first key points as the target center point, wherein the part of first key points are disposed in a center zone of the region corresponding to the plurality of first key points.

In some embodiments, the one or more processors are configured to perform:

determining a plurality of third key points in a third image, wherein the plurality of third key points are key points of the target part, and the third image is a previous frame of the first image;

determining a plurality of fourth key points in the first image, wherein the plurality of fourth key points are key points of the target part, and the fourth key points are determined by a key point determination model; and

determining the plurality of first key points based on the plurality of third key points and the plurality of fourth key points.

In some embodiments, the one or more processors are configured to perform:

determining, for each fourth key point, a first target key point in the plurality of third key points, wherein the first target key point and the fourth key point have an equal pixel value;

determining an average position of a first position and a second position, wherein the first position is a position of the first target key point, and the second position is a position of the fourth key point; and

acquiring the first key point by rendering the pixel value of the fourth key point to the average position.

In some embodiments, the one or more processors are configured to perform at least one of:

determining, in response to the target part being occluded, a second target key point in the plurality of third key points, wherein the second target key point is a key point corresponding to the occluded target part; and acquiring the plurality of first key points, wherein the plurality of first key points are formed based on the second target key point and the plurality of fourth key points; and

taking, in response to the target part being occluded, the plurality of third key points as the plurality of first key points.

In some embodiments, the one or more processors are configured to perform:

determining a second adjustment parameter in response to the target part being occluded, wherein the second adjustment parameter is a parameter for adjusting the third image; and

acquiring the first adjustment parameter by adjusting the second adjustment parameter based on a predetermined amplitude.

In some embodiments, the one or more processors are configured to perform:

determining a number of consecutive frames of an image with the target part being occluded; and

stopping image processing of a next frame image in response to the number reaching a target value.

In the embodiment of the present disclosure, the target region is acquired by expanding the region where the target part is disposed in the first image, such that a change of the target part in the adjusted second image can gradually affect other regions in the first image, which prevents image distortion caused by an influence on the pixel points in other regions in the image when the target part is adjusted, and the image processing effects are optimized.

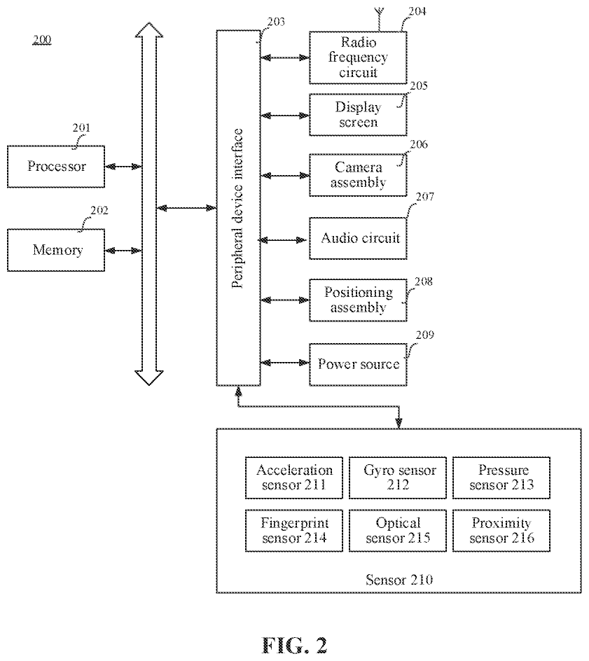

In some embodiments, the electronic device is provided as a terminal. FIG. 2 is a block diagram of a terminal according to an exemplary embodiment. In some embodiments, the terminal 200 is a smart phone, a tablet computer, a moving picture experts group audio layer III (MP3) player, a moving picture experts group audio layer IV (MP4) player, a laptop, or a desk computer. The terminal 200 may also be called user equipment (UE), a portable terminal, a laptop terminal, a desk terminal, or the like.

Generally, the terminal 200 includes one or more processors 201 and a transitory or non-transitory memory 202.

In some embodiments, the processor 201 includes one or more processing cores, such as a 4-core processor and an 8-core processor. The processor 101 is formed by at least one hardware of a digital signal processing (DSP), a field-programmable gate array (FPGA), and a programmable logic array (PLA). In some embodiments, the processor 201 includes a main processor and a coprocessor. The main processor is a processor for processing the data in an awake state, and is also called a central processing unit (CPU). The coprocessor is a low-power-consumption processor for processing the data in a standby state. In some embodiments, the processor 201 is integrated with a graphics processing unit (GPU), which is configured to render and draw the content that needs to be displayed by a display screen. In some embodiments, the processor 201 also includes an artificial intelligence (AI) processor configured to process computational operations related to machine learning.

The memory 202 includes one or more computer-readable storage mediums, which are non-transitory. The memory 202 also includes a high-speed random access memory, as well as a non-volatile memory, such as one or more disk storage devices and flash storage devices. In some embodiments, the non-transitory computer-readable storage medium in the memory 202 is configured to store at least one instruction. The at least one instruction is configured to be executed by the processor 201 to implement the method for processing images according to the method embodiments of the present disclosure.

In some embodiments, the terminal 200 also optionally includes a peripheral device interface 203 and at least one peripheral device. The processor 201, the memory 202, and the peripheral device interface 203 are connected by a bus or a signal line. Each peripheral device is connected to the peripheral device interface 203 by a bus, a signal line, or a circuit board. Specifically, the peripheral device includes at least one of a radio frequency circuit 204, a touch display screen 205, a camera assembly 206, an audio circuit 207, a positioning assembly 208, and a power source 209.

The peripheral device interface 203 may be configured to connect at least one peripheral device associated with an input/output (I/O) to the processor 201 and the memory 202. In some embodiments, the processor 201, the memory 202, and the peripheral device interface 203 are integrated on the same chip or circuit board. In some other embodiments, any one or two of the processor 201, the memory 202, and the peripheral device interface 203 are implemented on a separate chip or circuit board, which is not limited in the present embodiment.

The radio frequency circuit 204 is configured to receive and transmit a radio frequency (RF) signal, which is also referred to as an electromagnetic signal. The radio frequency circuit 204 communicates with a communication network and other communication devices via the electromagnetic signal. The radio frequency circuit 204 converts the electrical signal into the electromagnetic signal for transmission, or converts the received electromagnetic signal into the electrical signal. Optionally, the radio frequency circuit 204 includes an antenna system, an RF transceiver, one or more amplifiers, a tuner, an oscillator, a digital signal processor, a codec chipset, a subscriber identity module card, and the like. The radio frequency circuit 204 communicates with other electronic devices via at least one wireless communication protocol. The wireless communication protocol includes, but is not limited to, a metropolitan area network, various generations of mobile communication networks (2G, 3G, 4G, and 5G), a wireless local area network, and/or a wireless fidelity (Wi-Fi) network. In some embodiments, the RF circuit 204 also includes near-field communication (NFC) related circuits, which is not limited in the present disclosure.

The display screen 205 is configured to display a user interface (UI). The UI includes graphics, text, icons, videos, and any combination thereof. In response to the display screen 205 being a touch display screen, the display screen 205 also has the capacity to acquire touch signals on or over the surface of the display screen 205. The touch signal is input into the processor 201 as a control signal for processing. At this time, the display screen 205 is also configured to provide virtual buttons and/or virtual keyboards, which are also referred to as soft buttons and/or soft keyboards. In some embodiments, one display screen 205 is disposed on the front panel of the terminal 200. In some other embodiments, at least two display screens 205 are disposed respectively on different surfaces of the terminal 200 or in a folded design. In further embodiments, the display screen 205 is a flexible display screen disposed on the curved or folded surface of the terminal 200. Even the display screen 205 is also set to an irregular shape other than a rectangle; that is, the display screen 205 is an irregular-shaped screen. The display screen 205 is a liquid crystal display (LCD) screen, an organic light-emitting diode (OLED) screen, or the like.

The camera assembly 206 is configured to capture images or videos. In some embodiments of the present disclosure, the camera assembly 206 includes a front camera and a rear camera. Usually, the front camera is placed on the front panel of the terminal 200, and the rear camera is placed on the back of the terminal 200. In some embodiments, at least two rear cameras are disposed, and are any one of a main camera, a depth-of-field camera, a wide-angle camera, and a telephoto camera respectively, so as to realize a background blurring function achieved by fusion of the main camera and the depth-of-field camera, panoramic shooting, and virtual reality (VR) shooting functions achieved by fusion of the main camera and the wide-angle camera or other fusion shooting functions. In some embodiments, the camera assembly 206 also includes a flashlight. The flashlight is a mono-color temperature flashlight or a two-color temperature flashlight. The two-color temperature flash is a combination of a warm flashlight and a cold flashlight and is used for light compensation at different color temperatures.

The audio circuit 207 includes a microphone and a speaker. The microphone is configured to capture sound waves of users and environments, and convert the sound waves into electrical signals which are input into the processor 201 for processing, or input into the RF circuit 204 for voice communication. For the purpose of stereo acquisition or noise reduction, there are a plurality of microphones respectively disposed at different locations of the terminal 200. In some embodiments, the microphone is an array microphone or an omnidirectional acquisition microphone. The speaker is then configured to convert the electrical signals from the processor 201 or the radio frequency circuit 204 into the sound waves. The speaker is a conventional film speaker or a piezoelectric ceramic speaker. In response to the speaker being the piezoelectric ceramic speaker, the electrical signal can be converted into not only human-audible sound waves but also the sound waves which are inaudible to humans for the purpose of ranging and the like. In some embodiments, the audio circuit 207 also includes a headphone jack.

The positioning assembly 208 is configured to locate the current geographic location of the terminal 200 to implement navigation or location based service (LBS). The positioning assembly 208 is a positioning assembly based on the American global positioning system (GPS), the Chinese Beidou system, the Russian Glonass system, or the European Union's Galileo system.

The power source 209 is configured to power up various assemblies in the terminal 200. The power source 209 is alternating current, direct current, a disposable battery, or a rechargeable battery. In response to the power source 209 including the rechargeable battery, the rechargeable battery supports wired charging or wireless charging. The rechargeable battery also supports a fast charging technology.

In some embodiments, the terminal 200 also includes one or more sensors 210. The one or more sensors 210 include, but are not limited to, an acceleration sensor 211, a gyro sensor 212, a pressure sensor 213, a fingerprint sensor 214, an optical sensor 215, and a proximity sensor 216.

The acceleration sensor 211 detects magnitudes of accelerations on three coordinate axes of a coordinate system established by the terminal 200. For example, the acceleration sensor 211 is configured to detect components of a gravitational acceleration on the three coordinate axes. The processor 201 controls the touch display screen 205 to display a user interface in a landscape view or a portrait view according to a gravity acceleration signal captured by the acceleration sensor 211. The acceleration sensor 211 is also configured to capture motion data of a game or a user.

The gyro sensor 212 detects a body direction and a rotation angle of the terminal 200, and cooperates with the acceleration sensor 211 to capture a 3D motion of the user on the terminal 200. Based on the data captured by the gyro sensor 212, the processor 201 serves the following functions: motion sensing (such as changing the UI according to a user's tilt operation), image stabilization during shooting, game control, and inertial navigation.

The pressure sensor 213 is disposed on a side frame of the terminal 200 and/or a lower layer of the touch display screen 205. In response to the pressure sensor 213 being disposed on the side frame of the terminal 200, a user's holding signal to the terminal 200 is detected. The processor 201 performs left-right hand recognition or quick operation according to the holding signal captured by the pressure sensor 213. In response to the pressure sensor 213 being disposed on the lower layer of the touch display screen 205, the processor 201 controls an operable control on the UI according to a user's pressure operation on the touch display screen 205. The operable control includes at least one of a button control, a scroll bar control, an icon control, and a menu control.

The fingerprint sensor 214 is configured to capture a user's fingerprint. The processor 201 identifies the user's identity based on the fingerprint captured by the fingerprint sensor 214, or the fingerprint sensor 214 identifies the user's identity based on the captured fingerprint. In the case that the user's identity is identified as trusted, the processor 201 authorizes the user to perform related sensitive operations, such as unlocking the screen, viewing encrypted information, downloading software, paying, and changing settings. The fingerprint sensor 214 is disposed on the front, back, or side of the terminal 200. In response to the terminal 200 being provided with a physical button or a manufacturer's Logo, the fingerprint sensor 214 is integrated with the physical button or the manufacturer's Logo.

The optical sensor 215 is configured to capture ambient light intensity. In some embodiments, the processor 201 controls the display brightness of the touch display screen 205 according to the ambient light intensity collected by the optical sensor 215. Specifically, in response to the ambient light intensity being high, the display brightness of the touch display screen 205 is increased; and in response to the ambient light intensity being low, the display brightness of the touch display screen 205 is decreased. In some other embodiments, the processor 201 also dynamically adjusts shooting parameters of the camera assembly 206 according to the ambient light intensity captured by the optical sensor 215.

The proximity sensor 216, also referred to as a distance sensor, is usually disposed on the front panel of the terminal 200. The proximity sensor 216 is configured to capture a distance between the user and a front surface of the terminal 200. In some embodiments, in response to the proximity sensor 216 detecting that the distance between the user and the front surface of the terminal 200 becomes gradually smaller, the processor 201 controls the touch display screen 205 to switch from a screen-on state to a screen-off state; and in response to the proximity sensor 216 detecting that the distance between the user and the front surface of the terminal 200 gradually increases, the processor 201 controls the touch display screen 205 to switch from the screen-off state to the screen-on state.

It will be understood by those skilled in the art that the structure shown in FIG. 2 does not constitute a limitation to the terminal 200, and can include more or fewer components than those illustrated, or combine some components or adopt different assembly arrangements.

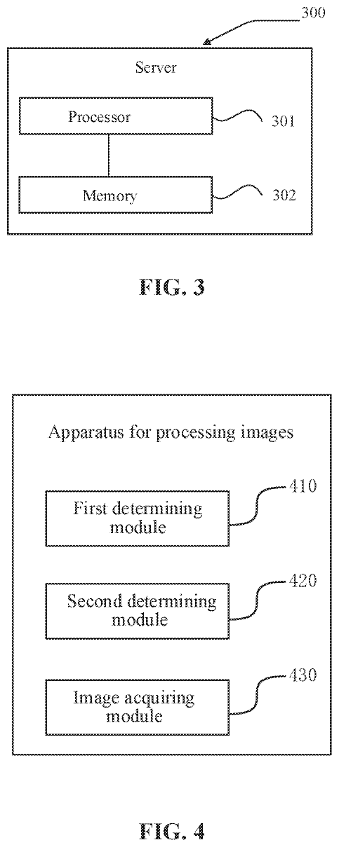

In some embodiments, the electronic device is provided as a server. FIG. 3 is a schematic structural diagram of a server according to an exemplary embodiment. The server 300 may vary greatly due to different configurations or performances, and includes one or more processors (central processing units, CPU) 301 and one or more memories 302, wherein at least one instruction is stored in the memory 302, and the at least one instruction is loaded and executed by the processor 301 to perform the methods according to the above method embodiments. In addition, the server 300 also has components such as a wired or wireless network interface, a keyboard, and an input and output interface for input and output, and the server also includes other components for implementing device functions, which are not repeated here.

In an exemplary embodiment, a computer-readable storage medium is also provided, and the computer-readable storage medium stores instructions therein. The above instructions, when executed by a processor of an electronic device, cause the electronic device to perform:

determining a plurality of first key points in a first image, wherein the plurality of first key points are key points of a target part;

determining a target region of the first image by expanding a region corresponding to the plurality of first key points; and

acquiring a second image by adjusting positions of pixel points in a first partial image and a second partial image based on a center point of the region corresponding to the plurality of first key points and a first adjustment parameter, the first partial image being an image corresponding to the region corresponding to the plurality of first key points, and the second partial image being an image other than the first partial image in the target region.

The computer-readable storage medium is a read-only medium (ROM), a random access memory (RAM), a compact disc read-only memory (CD-ROM), a magnetic tape, a floppy disc, an optical data storage device, and the like.

In the embodiment of the present disclosure, the target region is acquired by expanding the region where the target part is disposed in the first image, such that a change of the target part in the adjusted second image can gradually affect other regions in the first image, which prevents image distortion caused by an influence on the pixel points in other regions in the image when the target part is adjusted, and the image processing effects are optimized.

The present disclosure also provides a computer program product. Instructions in the computer program product, when executed by a processor of an electronic device, cause the electronic device to perform:

determining a plurality of first key points in a first image, wherein the plurality of first key points are key points of a target part;

determining a target region of the first image by expanding a region corresponding to the plurality of first key points; and

acquiring a second image by adjusting positions of pixel points in a first partial image and a second partial image based on a center point of the region corresponding to the plurality of first key points and a first adjustment parameter, the first partial image being an image corresponding to the region corresponding to the plurality of first key points, and the second partial image being an image other than the first partial image in the target region.

In the embodiment of the present disclosure, the target region is acquired by expanding the region where the target part is disposed in the first image, such that a change of the target part in the adjusted second image can gradually affect other regions in the first image, which prevents image distortion caused by an influence on the pixel points in other regions in the image when the target part is adjusted, and the image processing effects are optimized.

FIG. 4 is a block diagram of an apparatus for processing images according to an exemplary embodiment. Referring to FIG. 4, the apparatus includes:

a first determining module 410 configured to determine a plurality of first key points in a first image, wherein the plurality of first key points are key points of a target part;

a second determining module 420 configured to determine a target region of the first image by expanding a region corresponding to the plurality of first key points; and

an image acquiring module 430 configured to acquire a second image by adjusting positions of pixel points in a first partial image and a second partial image based on a center point of the region corresponding to the plurality of first key points and a first adjustment parameter, the first partial image being an image corresponding to the region corresponding to the plurality of first key points, and the second partial image being an image other than the first partial image in the target region.

In some embodiments, the image acquiring module 430 includes:

a shape adjusting unit, configured to adjust a shape of the first partial image based on the center point of the region corresponding to the plurality of first key points and the first adjustment parameter; and

a dispersing unit, configured to disperse the pixel points in the second partial image to acquire the second image.

In some embodiments, the dispersing unit is configured to determine a first movement direction in response to the first partial image being zoomed out, wherein the first movement direction is a direction approaching the center point; determine a first movement distance based on the first adjustment parameter; and acquire the second image by moving the pixel points in the second partial image by the first movement distance in the first movement direction.

In some embodiments, the dispersing unit is configured to determine a second movement direction in response to the first partial image being zoomed in, wherein the second movement direction is a direction going away from the center point; determine a second movement distance based on the first adjustment parameter, and acquire the second image by moving the pixel points in the second partial image by the second movement distance in the second movement direction.

In some embodiments, the second determining module 420 includes:

a first determining unit, configured to determine a target center point, wherein the target center point is acquired based on the plurality of first key points;

a second determining unit, configured to determine, for each first key point, a second key point, wherein the second key point, the first key point, and the target center point are on one straight line, and a first distance is greater than a second distance, the first distance being a distance between the second key point and the target center point, and the second distance being a distance between the first key point and the target center point; and

a third determining unit, configured to determine the target region based on a plurality of second key points.

In some embodiments, the first determining unit is configured to determine a center point of the plurality of first key points as the target center point; and

the first determining unit is configured to determine a center point of a part of the first key points as the target center point, wherein the part of first key points are disposed in a center zone of the region corresponding to the plurality of first key points.

In some embodiments, the first determining module 410 includes:

a fourth determining unit, configured to determine a plurality of third key points in a third image, wherein the plurality of third key points are key points of the target part, and the third image is a previous frame of the first image;

a fifth determining unit, configured to determine a plurality of fourth key points in the first image, wherein the plurality of fourth key points are key points of the target part, and the fourth key points are determined by a key point determination model; and

a sixth determining unit, configured to determine the plurality of first key points based on the plurality of third key points and the plurality of fourth key points.

In some embodiments, the sixth determining unit is configured to determine, for each fourth key point, a first target key point in the plurality of third key points, wherein the first target key point and the fourth key point have an equal pixel value; determine an average position of a first position and a second position, wherein the first position is a position of the first target key point, and the second position is a position of the fourth key point; and acquire the first key point by rendering the pixel value of the fourth key point to the average position.

In some embodiments, the sixth determining unit is configured to determine, in response to the target part being occluded, a second target key point in the plurality of third key points, wherein the second target key point is a key point corresponding to the occluded target part; and acquire the plurality of first key points, wherein the plurality of first key points are formed based on the second target key point and the plurality of fourth key points; and

the sixth determining unit is configured to take, in response to the target part being occluded, the plurality of third key points as the plurality of first key points.

In some embodiments, the apparatus further includes:

a third determining module, configured to determine a second adjustment parameter in response to the target part being occluded, wherein the second adjustment parameter is a parameter for adjusting the third image; and

a fourth determining module, configured to acquire the first adjustment parameter by adjusting the second adjustment parameter based on a predetermined amplitude.

In some embodiments, the apparatus further includes:

a fifth determining module, configured to determine a number of consecutive frames of an image with the target part being occluded; and

an image processing module, configured to stop image processing of a next frame image in response to the number reaching a target value.

It should be noted that the apparatus for processing images according to the above embodiment only takes division of above respective functional modules as an example for explanation when performing image processing. In practice, the above functions can be finished by the different functional modules as required. That is, the internal structure of the electronic device is divided into different functional modules to finish all or part of the functions described above. In addition, the apparatus for processing images according to the above embodiment has the same concept as the embodiments of the methods for processing images. The method embodiments are referred for the specific implementation process, which are not repeated here.

In the embodiment of the present disclosure, the target region is acquired by expanding the region where the target part is disposed in the first image, such that a change of the target part in the adjusted second image can gradually affect other regions in the first image, which prevents image distortion caused by an influence on the pixel points in other regions in the image when the target part is adjusted, and the image processing effects are optimized.

In the related art, in response to a user wanting to beautify a certain part in an image, an electronic device generally acquires a plurality of key points corresponding to the part in the face image, and adjusts the positions of the plurality of key points corresponding to the part in the face image, such that the beautification of the part is realized. For example, in the case that the user wants to zoom in eyes in the face image, a plurality of key points corresponding to the eyes are moved outward with the eyes as the center through the electronic device, so as to realize zooming in of the eyes. For another example, in the case that the user wants to thin eyebrows in the face image, a plurality of key points corresponding to the eyebrows are moved inward with the eyebrows as the center through the electronic device, so as to realize eyebrow thinning.

In the above related art, in the case that the eyes are zoomed in, the plurality of key points corresponding to the eyes are moved outward with the eyes as the center, and the moved key points will occupy positions of pixel points around the eyes, as a result, the pixel points around the eyes will be accumulated. Moreover, in the case that the eyebrows are thinned, the plurality of key points corresponding to the eyebrows are moved inward with the eyebrows as the center, as a result, the pixel points around the eyebrows after eyebrow thinning will be lacked. It can be seen that the modes for processing images in the related art will cause image distortion due to a sudden change of the positions of the image pixel points, and a beautifying effect of the face image is poor.

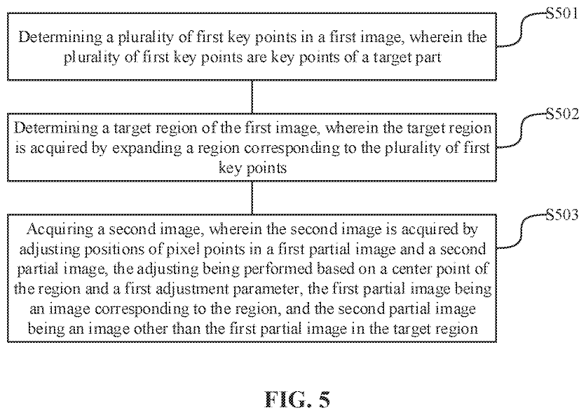

FIG. 5 is a flowchart of a method for processing images according to an exemplary embodiment. Referring to FIG. 5, the method for processing images is executed by an electronic device, and the method for processing images includes the following steps.

In S501, a plurality of first key points in a first image are determined, wherein the plurality of first key points are key points of a target part.

In S502, a target region of the first image is determined by expanding a region corresponding to the plurality of first key points.

In S503, a second image is acquired by adjusting positions of pixel points in a first partial image and a second partial image based on a center point of the region corresponding to the plurality of first key points and a first adjustment parameter, the first partial image being an image corresponding to the region corresponding to the plurality of first key points, and the second partial image being an image other than the first partial image in the target region.

In some embodiments, acquiring the second image includes:

adjusting a shape of the first partial image based on the center point of the region corresponding to the plurality of first key points and the first adjustment parameter; and

dispersing the pixel points in the second partial image to acquire the second image.

In some embodiments, dispersing the pixel points in the second partial image to acquire the second image includes:

determining a first movement direction in response to the first partial image being zoomed out, wherein the first movement direction is a direction approaching the center point;

determining a first movement distance based on the first adjustment parameter; and

acquiring the second image by moving the pixel points in the second partial image by the first movement distance in the first movement direction.

In some embodiments, dispersing the pixel points in the second partial image to acquire the second image includes:

determining a second movement direction in response to the first partial image being zoomed in, wherein the second movement direction is a direction going away from the center point;

determining a second movement distance based on the first adjustment parameter, and

acquiring the second image by moving the pixel points in the second partial image by the second movement distance in the second movement direction.

In some embodiments, determining the target region of the first image includes:

determining a target center point, wherein the target center point is acquired based on the plurality of first key points;

determining for each first key point, a second key point, wherein the second key point, the first key point, and the target center point are on one straight line, and a first distance is greater than a second distance, the first distance being a distance between the second key point and the target center point, and the second distance being a distance between the first key point and the target center point; and

determining the target region based on a plurality of second key points.

In some embodiments, determining the target center point includes any one of:

determining a center point of the plurality of first key points as the target center point; and

determining a center point of a part of the first key points as the target center point, wherein the part of first key points are disposed in a center zone of the region corresponding to the plurality of first key points.

In some embodiments, determining the plurality of first key points in the first image includes:

determining a plurality of third key points in a third image, wherein the plurality of third key points are key points of the target part, and the third image is a previous frame of the first image;

determining a plurality of fourth key points in the first image, wherein the plurality of fourth key points are key points of the target part, and the fourth key points are determined by a key point determination model; and

determining the plurality of first key points based on the plurality of third key points and the plurality of fourth key points.

In some embodiments, determining the plurality of first key points includes:

determining, for each fourth key point, a first target key point in the plurality of third key points, wherein the first target key point and the fourth key point have an equal pixel value;

determining an average position of a first position and a second position, wherein the first position is a position of the first target key point, and the second position is a position of the fourth key point; and

acquiring the first key point by rendering the pixel value of the fourth key point to the average position.

In some embodiments, determining the plurality of first key points includes any one of:

determining, in response to the target part being occluded, a second target key point in the plurality of third key points, wherein the second target key point is a key point corresponding to the occluded target part; and acquiring the plurality of first key points, wherein the plurality of first key points are formed based on the second target key point and the plurality of fourth key points; and

taking, in response to the target part being occluded, the plurality of third key points as the plurality of first key points.

In some embodiments, the method further includes:

determining a second adjustment parameter in response to the target part being occluded, wherein the second adjustment parameter is a parameter for adjusting the third image; and

acquiring the first adjustment parameter by adjusting the second adjustment parameter based on a predetermined amplitude.

In some embodiments, the method further includes:

determining a number of consecutive frames of an image with the target part being occluded; and

stopping image processing of a next frame image in response to the number reaching a target value.

In the embodiment of the present disclosure, the target region is acquired by expanding the region where the target part is disposed in the first image, such that a change of the target part in the adjusted second image can gradually affect other regions in the first image, which prevents image distortion caused by an influence on the pixel points in other regions in the image when the target part is adjusted, and the image processing effects are optimized.

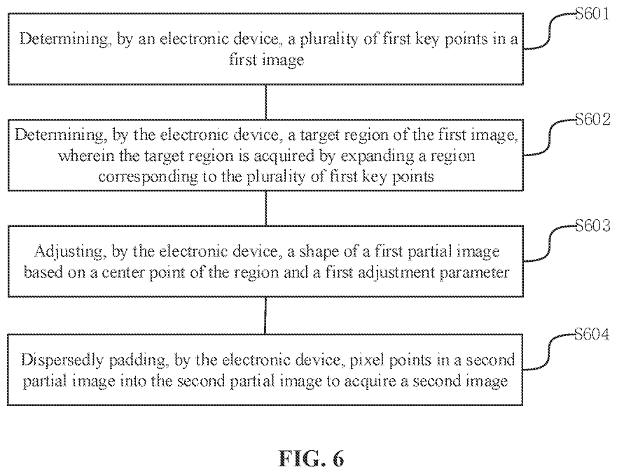

FIG. 6 is a flowchart of a method for processing images according to an exemplary embodiment. Referring to FIG. 6, the method for processing images includes the following steps.

In S601, an electronic device determines a plurality of first key points in a first image.

The plurality of first key points are key points of a target part. The target part is facial features in a facial region or a facial contour in the first image, for example, the target part is eyes, eyebrows, a nose bridge, a mouth, cheeks, or the like. Alternatively, the target part is other body parts, such as a waist and legs.

The target part is a target part selected by a user, or the target part is a pre-determined target part. In some embodiments, the electronic device receives a selection operation of the user, and determines the target part selected by the user based on the selection operation. In some embodiments, the electronic device sets the target part for shape adjustment in advance, and in this step, the electronic device directly calls the target part set in advance, which is not specifically limited in the embodiment of the present disclosure. It should be noted that the target part is a part in the first image. Alternatively, the target part is a plurality of parts in the first image, which is not specifically limited in the embodiment of the present disclosure.

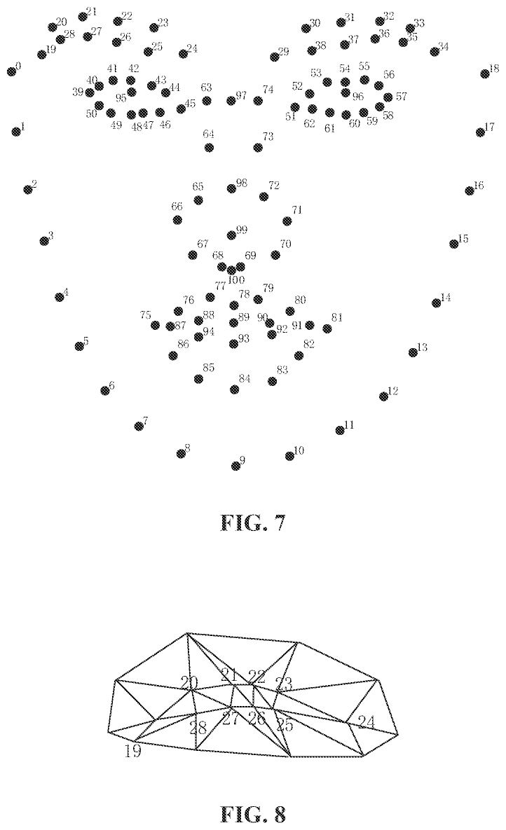

In this step, the electronic device determines the plurality of first key points of the target part. For example, referring to FIG. 7, which is a schematic diagram showing key points of the facial region according to an exemplary embodiment. In FIG. 7, in the case that the target part is the eyebrow, the plurality of first key points are 10 key points numbered 19-28.

In some embodiments, the electronic device only determines the plurality of first key points of the target part based on the current first image. Alternatively, the electronic device determines the plurality of first key points corresponding to the target part by a previous frame of the first image. In some embodiments, the electronic device may directly determine the plurality of first key points corresponding to the target part from the first image. In this embodiment, the electronic device directly determines the plurality of first key points corresponding to the target part from the first image, thereby simplifying a processing flow of determining the plurality of first key points and improving the efficiency of image processing.

In some embodiments, the electronic device determines the plurality of first key points corresponding to the target part based on a plurality of third key points, wherein the plurality of third key points are key points of the target part in the previous frame of the first image. The process is achieved through the following steps (A1)-(A3), including:

(A1) The electronic device determines the plurality of third key points in a third image.

The plurality of third key points are key points of the target part, and the third image is the previous frame of the first image.

In some embodiments, the electronic device stores the plurality of key points of the third image therein. In this step, the electronic device directly determines the plurality of third key points from the plurality of key points according to the target part. In this embodiment, the acquired images are processed in advance in the electronic device, and a corresponding relationship between each image and the pixel points is stored, such that the plurality of third key points can be directly determined according to the target part, which simplifies the process of acquiring the plurality of third key points, and improves the processing efficiency.

In some embodiments, the electronic device determines the plurality of third key points through a first determination model. The electronic device inputs the third image into the first determination model to acquire all key points of the third image; and determines the plurality of third key points from all the key points. Alternatively, the electronic device inputs the third image into a second determination model, and the second determination model outputs the plurality of third key points.

The first determination model and the second determination model are any neural network model. Accordingly, before this step, the electronic device performs model training as required, and the first determination model and the second determination model are acquired by training through adjusting model parameters.

In addition, the number of the key points is set as required, and in the embodiment of the present disclosure, the number of the key points is not specifically limited, for example, the number of the key points is 100, 101, 105, or the like. Referring to FIG. 7, FIG. 7 shows 101 key points of the facial region.

In this embodiment, the plurality of third key points are determined through the model, thereby improving the accuracy of determining the plurality of third key points.

(A2) The electronic device determines a plurality of fourth key points in the first image.

The plurality of fourth key points are the key points of the target part, and the fourth key points are determined by a key point determination model.

This step is similar to the process of determining the plurality of third key points by the electronic device in step (A1), which is not repeated here.

(A3) The electronic device determines the plurality of first key points.

The plurality of first key points are determined based on the plurality of third key points and the plurality of fourth key points.

In this step, the electronic device renders pixel values of the plurality of fourth key points at an average position to acquire the plurality of first key points, and the process is implemented through the following steps (a1)-(a3), including:

(a1) For each fourth key point, the electronic device determines a first target key point in the plurality of third key points.

The first target key point and the fourth key point have an equal pixel value.

In some embodiments, the electronic device firstly selects any fourth key point, and then determines the first target key point having an equal pixel value as the fourth key point from the plurality of third key points.

(a2) The electronic device determines the average position of a first position and a second position.

The first position is a position of the third key point, and the second position is a position of the fourth key point. In some embodiments, the electronic device establishes the same coordinate system in the third image and the first image, coordinate positions of the third key point and the fourth key point which have the equal pixel value are respectively determined in the same coordinate system, so as to acquire the first position and second position, and the first position and the second position are averaged to acquire the average position.

In some embodiments, the electronic device respectively establishes different coordinate systems in the third image and the first image, coordinate positions of the third key point and the fourth key point in respective coordinate systems are respectively determined, and then by a mapping relationship between the coordinate systems, the coordinate positions of the third key point and the fourth key point in the same coordinate system are acquired.

It should be noted that the electronic device firstly determines the first positions of the plurality of third key points, and then determines the second positions of the plurality of fourth key points. Alternatively, the electronic device firstly determines the second positions of the plurality of fourth key points, and then determines the first positions of the plurality of third key points. Alternatively, the electronic device simultaneously determines the first positions of the plurality of third key points and the second positions of the plurality of fourth key points. In the embodiment of the present disclosure, the order in which the electronic device determines the first positions and the second positions is not specifically limited.

(a3) The electronic device acquires the first key point.

The first key point is acquired by rendering the pixel value of the fourth key point to the average position.

It should be noted that the electronic device can also average the positions of other pixel points in the third image and the first image according to the corresponding relationship between the third key point and the fourth key point, so as to adjust all the pixel points in the first image.

It should also be noted that the electronic device also performs weighted summation on the pixel value of the third key point and the pixel value of the fourth key point, and takes the pixel value acquired by weighted summation as the pixel value of the plurality of first key points for rendering.

In the embodiment, by averaging the positions of the plurality of third key points and the plurality of fourth key points with the equal pixel value, the plurality of first key points are acquired, such that the positions of the plurality of first key points in the first image can be changed smoothly to prevent the positions of the first key points in the captured first image from a sudden change, thereby ensuring that the image in the first image can also be smooth and stable when a dynamic animation is captured.

In addition, in the process of capturing image, the case that the image is occluded may occur. In the case that there is no target part occluded in the first image, the electronic device directly takes the plurality of fourth key points as the plurality of first key points. In the case that the target part in the first image is occluded, the fourth key points acquired by the electronic device will lack key points, and then the electronic device determines the plurality of first key points by acquiring the target part in the previous frame. Accordingly, after capturing the first image, the electronic device identifies the key points in the first image, in response to the occluded target part in the first image detected by the electronic device, the electronic device acquires the third image captured before, and the third image is an image with complete key points.

In some embodiments, the electronic device selects the lacked fourth key point from the plurality of third key points, and accordingly, the process is that in response to the target part being occluded, the electronic device determines a second target key point in the plurality of third key points, wherein the second target key point is the key point corresponding to the occluded target part; and the plurality of first key points are acquired, wherein the plurality of first key points are formed based on the second target key point and the plurality of fourth key points.

In some embodiments, the electronic device directly takes the plurality of third key points as the first key points, and the process is that in response to the target part being occluded, the electronic device takes the plurality of third key points as the plurality of first key points.

In S602, the electronic device determines a target region of the first image, wherein the target region is acquired by expanding the region corresponding to the plurality of first key points.

In this step, the electronic device determines the region corresponding to the plurality of first key points in the first image, and then expands the region corresponding to the plurality of first key points to acquire the target region. The process is achieved through the following steps (1)-(2), including:

(1) The electronic device determines a region defined by the plurality of first key points.

Since the region defined by the plurality of first key points is determined based on the plurality of first key points, the region defined by the plurality of first key points can be referred as the region corresponding to the plurality of first key points. The electronic device connects adjacent first key points in sequence, and takes the image region defined by the plurality of first key points as the region corresponding to the plurality of first key points.

(2) The electronic device expands the region corresponding to the plurality of first key points to acquire the target region.

The process is achieved through the following steps (2-1)-(2-3), including:

(2-1) The electronic device determines a target center point.

The target center point is acquired based on the plurality of first key points.

In some embodiments, the electronic device determines a center point of the plurality of first key points as the target center point. For example, continue to refer to FIG. 7, which takes the eyebrow as an example of the target part for illustration. The plurality of first key points corresponding to the eyebrow are 10 key points 19-28, and the electronic device determines the center point corresponding to the 10 key points.

In some embodiments, the electronic device firstly selects part of the first key points in the center region from the plurality of first key points, and then determines the center point of the part of first key points. Accordingly, the electronic device determines the center point of the part of first key points as the target center point, and the part of first key points are disposed in the center zone of the region corresponding to the plurality of first key points. For example, continue to refer to FIG. 7, which takes the eyebrow as an example of the target part for illustration. The plurality of first key points corresponding to the eyebrow are the 10 key points 19-28. The electronic device firstly selects four key points in the middle positions from the key points 19-28, such as key points 21, 22, 26 and 27, and determines an average point of these four key points as the center point.

(2-2) For each first key point, the electronic device determines a second key point, wherein the second key point, the first key point, and the target center point are on one straight line, and a first distance is greater than a second distance, the first distance being a distance between the second key point and the target center point, and the second distance being a distance between the first key point and the target center point.

In this step, the electronic device connects the target center point as an endpoint to each first key point to form a ray. For example, the example in the above step (1) is continued to be taken as an example for illustration, the average point of the first key points 21, 22, 26, and 27 is taken as the target center point, and rays are respectively formed toward the directions of the first key points 19-28 to acquire 10 rays. Then, the electronic device determines the second key point from each ray to acquire the plurality of second key points, and the distance between the second key point and the target center point is greater than the distance between first key point on the ray where the second key point is disposed and the target center point.

In the step, the electronic device intercepts a line segment on the acquired ray with the target center point as the endpoint, and the other endpoint of the line segment is the second key point. The length of the line segment is greater than the length from the target center point on the ray to the first key point. The length of the line segment is a preset length determined according to an empirical value, and in the embodiment of the present disclosure, the length of the line segment is not specifically limited.

It should be noted that the process of determining the plurality of second key points is similar to the process of determining the plurality of third key points by the electronic device in step (A1) of step S601, and details are not repeated here.

(2-3) The electronic device determines the target region.

The target region is determined based on the plurality of second key points.

In some embodiments, the electronic device connects the plurality of second key points in sequence, and the image region defined by the plurality of second key points is taken as the target region. In some embodiments, the electronic device determines a mesh region corresponding to the plurality of second key points through a mesh algorithm, and takes the mesh region as the target region. The process is that the electronic device takes the plurality of second key points as endpoints, and performs mesh expansion on the target part corresponding to the plurality of first key points to acquire the mesh region. The electronic device forms the target region from the acquired mesh region and the region corresponding to the first key points. Referring to FIG. 8, the electronic device connects the plurality of second key points as the endpoints to the plurality of first key points respectively to realize mesh expansion, so as to acquire the mesh region in the form of triangular patches. The regions corresponding to the triangular patches and the first key points form the target region.

In S603, the electronic device adjusts a shape of a first partial image based on the center point of the region corresponding to the plurality of first key points and a first adjustment parameter.

The first partial image is an image corresponding to the region corresponding to the plurality of first key points. The first adjustment parameter is a parameter for adjusting the first partial image. The first adjustment parameter is a system default whole parameter, or a parameter generated based on user settings, or a parameter determined based on a second adjustment parameter of the third image. The first adjustment parameter at least includes an adjustment mode and an adjustment strength, and also includes a color parameter, a luminance parameter, and the like. The electronic device adjusts the shape of the target part based on the adjustment mode in the first adjustment parameter, and the shape adjustment is to perform a zoom-in adjustment, a zoom-out adjustment, and the like on the target part. The first adjustment parameter is an adjustment parameter input by the user and received by the electronic device. Alternatively, the first adjustment parameter is an adjustment parameter set based on different target parts in the electronic device. For example, in the case that the target part is the eyes, the adjustment parameter is to zoom in the eyes; in the case that the target part is the eyebrows, the adjustment parameter is to thin the eyebrows. Accordingly, the adjustment for the eyes is the zoom-in adjustment, and the adjustment for the eyebrows is the zoom-out adjustment.

The electronic device adjusts the shape of the first partial image, so as to zoom in or zoom out the target part. In some embodiments, the electronic device determines a relationship of respective pixel points in the first partial image according to a mesh algorithm, and adjusts a pixel list in the first partial image.

In some embodiments, the electronic device adjusts the target part through a liquefaction algorithm. The process is that the electronic device determines a center position corresponding to the target part, and forms a circle with the center position as a circle center, such that the first partial image corresponding to the target part is within the circle, and the adjustment of the first partial image corresponding to the target part is realized by changing a size of the circle.

The electronic device determines the first adjustment parameter for shape adjustment, and performs shape adjustment on the first partial image based on the first adjustment parameter. Correspondingly, the process that the electronic device performs, based on the first adjustment parameter, shape adjustment on the first partial image is implemented through the following steps (1)-(2), including:

(1) The electronic device determines the first adjustment parameter.

In some embodiments, the electronic device determines the current adjustment parameter as the first adjustment parameter. In some embodiments, in the case that the target part is not occluded, the electronic device determines the current adjustment parameter as the first adjustment parameter. In the case that the target part is occluded, the electronic device determines the first adjustment parameter based on the second adjustment parameter of the previous frame. Accordingly, the process of determining the first adjustment parameter is that the second adjustment parameter is determined in response to the target part being occluded, wherein the second adjustment parameter is a parameter for adjusting the third image; and the first adjustment parameter is acquired by adjusting the second adjustment parameter based on a predetermined amplitude.

The second adjustment parameter is an adjustment parameter used when the electronic device adjusts the third image. The second adjustment parameter is a system default adjustment parameter or an adjustment parameter generated based on user settings.

In the embodiment, by gradually changing the first adjustment parameter for the image, the process of adjusting the image can be smoother, thereby preventing a sudden change during image adjustment.

For example, in the process of capturing an image, the case that the image is occluded may occur. In this case, in response to the adjustment of the target part by the electronic device, the electronic device performs fault-tolerant processing. By selecting a target number of images as a delay time length, in the case of lacking a key frame, the previous frame can be continued and the target part of the current frame is adjusted. In addition, the adjustment amplitude is gradually weakened, and the first adjustment parameter is restored to the original adjustment parameter in response to the first key point being no longer lacked.

Accordingly, the electronic device determines the number of frames, which is the number of consecutive frames of the image with the target part being occluded; the image processing of the next frame image is stopped in response to the number reaching a target value.

In the process of recording the number of frames by the electronic device, in the case that it is detected that the target part of the image is no longer occluded before the number of frames reaches the target number of frames, the first adjustment parameter can be gradually restored to the second adjustment parameter. For example, in response to the current first image being an image lacking the fourth key point, the electronic device adds one to the number of frames of the image lacking the key point consecutively. The number of frames of the current image is n, and in response to the first image lacking a plurality of fourth key points, the electronic device updates the current number of frames to be n+1. In response to the current first image not being an image lacking the fourth key point, the electronic device clears the number of frames lacking the key point consecutively. The electronic device further increases the current adjustment parameter based on the predetermined amplitude until the adjustment parameter is restored to the second adjustment parameter.

It should be noted that the electronic device firstly adjusts the target part in the first image, and then determines the number of frames lacking the fourth key point consecutively. Alternatively, the electronic device firstly determines the number of frames lacking the fourth key point consecutively, and then adjusts the target part in the first image. Alternatively, the electronic device simultaneously adjusts the target part in the first image and determines the number of frames lacking the fourth key point consecutively, which is not specifically limited in the embodiment of the present disclosure. The target number of frames is set as required, and in the embodiment of the present disclosure, the target number of frames is not specifically limited. For example, the target number of frames is 50, 60, 80, or the like.

(2) The electronic device adjusts each pixel point in the first partial image based on the center point and the first adjustment parameter.

In the step, the electronic device keeps the position of the center point unchanged, and adjusts positions of the pixel points in the first partial image based on the first adjustment parameter to realize shape adjustment of the first partial image.

In the embodiment, the electronic device adjusts the position of each pixel point in the first partial image based on the first adjustment parameter and the center point, so as to realize the adjustment of the target part and prevent the adjustment of regions other than the target part, thereby improving the adjustment accuracy.

In S604, the electronic device disperses the pixel points in the second partial image to acquire a second image.

The second partial image is an image other than the first partial image in the target region. The electronic device adjusts the target part, such that the positions of the pixel points in the first partial image change, resulting in a distorted region in the target region. In this step, the electronic device also adjusts the positions of the pixel points in the target region following the first partial image, so as to achieve a smooth transition of the adjustment of the target region to other regions other than the first partial image, and prevent a sudden change in the image.

There are two processes of adjusting the first partial image, one process is to perform zoom-in adjustment on the first partial image, and the other process is to perform zoom-out adjustment on the first partial image. Accordingly, in this step, the electronic device disperses the pixel points of the second partial image in the target region in the first image, and there are two methods of acquiring the second image.

In the first implementation, in the case of performing the zoom-out adjustment, diffusion padding of the pixel points is realized by the following steps (A1)-(A3), including:

(A1) In response to the first partial image being zoomed out, the electronic device determines a first movement direction, wherein the first movement direction is a direction approaching the center point.

In the step, the first partial image is subjected to the zoom-out adjustment, such that a movement direction of the pixel points in the second partial image is consistent with a movement direction of the first partial image in the zoom-out process, thereby determining the movement direction of the pixel points in the second partial image as the direction approaching the center point.

(A2) The electronic device determines a first movement distance based on the first adjustment parameter.

In the step, the electronic device determines, based on the first adjustment parameter, the distorted region that may be generated by performing the zoom-out adjustment on the first partial image. The first movement distance that needs to be moved when the pixel points in the second partial image pad the distorted image is determined by the distorted region.

(A3) The electronic device determines the second image, wherein the second image is acquired by moving the pixel points in the second partial image by the first movement distance in the first movement direction.

It should be noted that the processes of adjusting the first partial image and the second partial image by the electronic device are performed synchronously, or the first partial image is adjusted at first, and then the second partial image is adjusted. In the case that the electronic device adjusts the first partial image and the second partial image synchronously, the first movement distance is determined directly based on the first adjustment parameter through a predetermined movement distance algorithm.

In some embodiments, the electronic device moves the pixel points in the second partial image and the pixel points in the first partial image to realize image adjustment of the first image. In some embodiments, by the triangular patch corresponding to each key point in the plurality of first key points, the electronic device adjusts, based on the movement distance and the movement direction of the first key points, the positions of the pixel points in the triangular patch corresponding to the second partial image, and adjusts the pixel points in the triangular patch based on the movement distance and movement direction of the first key points.

It should be noted that for the pixel points in any triangular patch, the movement distance and movement direction of each pixel point are the same or different. In the case that the movement distance and movement direction of each pixel point are the same, the electronic device averages the movement distance and movement direction directly based on the number of the pixel points; and in the case that the movement distance and movement direction of each pixel point are different, the electronic device determines the movement distances and movement directions of different pixel points.

In the second implementation, in the case of performing the zoom-in adjustment, diffusion padding of the pixel points is realized by the following steps (B1)-(B3), including:

(B1) In response to the first partial image being zoomed in, the electronic device determines a second movement direction, wherein the second movement direction is a direction going away from the center point.

In the step, the first partial image is subjected to the zoom-in adjustment, such that the movement direction of the pixel points in the second partial image is consistent with the movement direction of the first partial image in the zoom-in process, thereby determining the movement direction of the pixel points in the second partial image as the direction going away from the center point.

(B2) The electronic device determines a second movement distance based on the first adjustment parameter.

This step is similar to step (A2) in S605, which is not repeated here.

(B3) The electronic device determines the second image, wherein the second image is acquired by moving the pixel points in the second partial image by the second movement distance in the second movement direction.

This step is similar to step (A3) in S605, which is not repeated here.

All the above optional technical solutions can be combined freely to form optional embodiments of the present disclosure, which are not repeated here.

Other embodiments of the present disclosure will be easily conceivable for those skilled in the art from consideration of the description and practice of the present disclosure. The present disclosure is intended to cover any variations, uses, or adaptive changes of the present disclosure, which follow general principles of the present disclosure and include common general knowledge or conventional technical measures which are not disclosed in the present disclosure. The description and embodiments are to be considered as exemplary only, with a true scope and spirit of the present disclosure indicated by the following claims.

It will be appreciated that the present disclosure is not limited to the exact construction that has been described above and illustrated in the accompanying drawings, and that various modifications and changes can be made without departing from the scope thereof. The scope of the present disclosure is only limited by the appended claims.

What is claimed is:

1. A method for processing images, performed by an electronic device, comprising:
determining a plurality of first key points in a first image, wherein the plurality of first key points are key points of a target part;
determining a target region of the first image by expanding a region corresponding to the plurality of first key points; and
acquiring a second image by adjusting positions of pixel points in a first partial image and a second partial image based on a center point of the region corresponding to the plurality of first key points and a first adjustment parameter, the first partial image being an image corresponding to the region corresponding to the plurality of first key points, and the second partial image being an image other than the first partial image in the target region.

2. The method according to claim 1, wherein said acquiring the second image comprises:
adjusting a shape of the first partial image based on the center point of the region corresponding to the plurality of first key points and the first adjustment parameter; and
dispersing the pixel points in the second partial image to acquire the second image.

3. The method according to claim 2, wherein said dispersing the pixel points in the second partial image to acquire the second image comprises:
determining a first movement direction in response to the first partial image being zoomed out, wherein the first movement direction is a direction approaching the center point;
determining a first movement distance based on the first adjustment parameter, and
acquiring the second image by moving the pixel points in the second partial image by the first movement distance in the first movement direction.

4. The method according to claim 2, wherein said dispersing the pixel points in the second partial image to acquire the second image comprises:
determining a second movement direction in response to the first partial image being zoomed in, wherein the second movement direction is a direction going away from the center point;
determining a second movement distance based on the first adjustment parameter, and
acquiring the second image by moving the pixel points in the second partial image by the second movement distance in the second movement direction.

5. The method according to claim 1, wherein said determining the target region of the first image comprises:
determining a target center point, wherein the target center point is acquired based on the plurality of first key points;
determining, for each first key point, a second key point, wherein the second key point, the first key point, and the target center point are on one straight line, and a first distance is greater than a second distance, the first distance being a distance between the second key point and the target center point, and the second distance being a distance between the first key point and the target center point; and
determining the target region based on a plurality of second key points.

6. The method according to claim 5, wherein said determining the target center point comprises any one of:
determining a center point of the plurality of first key points as the target center point; and
determining a center point of a part of the first key points as the target center point, wherein the part of first key points are disposed in a center zone of the region corresponding to the plurality of first key points.

7. The method according to claim 1, wherein said determining the plurality of first key points in the first image comprises:
determining a plurality of third key points in a third image, wherein the plurality of third key points are key points of the target part, and the third image is a previous frame of the first image;
determining a plurality of fourth key points in the first image, wherein the plurality of fourth key points are key points of the target part, and the fourth key points are determined by a key point determination model; and
determining the plurality of first key points based on the plurality of third key points and the plurality of fourth key points.

8. The method according to claim 7, wherein said determining the plurality of first key points comprises:
determining, for each fourth key point, a first target key point in the plurality of third key points, wherein the first target key point and the fourth key point have an equal pixel value;
determining an average position of a first position and a second position, wherein the first position is a position of the first target key point, and the second position is a position of the fourth key point; and
acquiring the first key point by rendering the pixel value of the fourth key point to the average position.

9. The method according to claim 7, wherein said determining the plurality of first key points comprises any one of:
determining, in response to the target part being occluded, a second target key point in the plurality of third key points, wherein the second target key point is a key point corresponding to the occluded target part; and acquiring the plurality of first key points, wherein the plurality of first key points are formed based on the second target key point and the plurality of fourth key points; and
taking, in response to the target part being occluded, the plurality of third key points as the plurality of first key points.

10. The method according to claim 7, further comprising:
determining a second adjustment parameter in response to the target part being occluded, wherein the second adjustment parameter is a parameter for adjusting the third image; and
acquiring the first adjustment parameter by adjusting the second adjustment parameter based on a predetermined amplitude.

11. The method according to claim 10, further comprising:
determining a number of consecutive frames of an image with the target part being occluded; and
stopping image processing of a next frame image in response to the number reaching a target value.

12. An electronic device, comprising:
one or more processors, and
a transitory or non-transitory memory configured to store instructions executable by the one or more processors;
wherein the one or more processors are configured to perform:
determining a plurality of first key points in a first image, wherein the plurality of first key points are key points of a target part;
determining a target region of the first image by expanding a region corresponding to the plurality of first key points; and
acquiring a second image by adjusting positions of pixel points in a first partial image and a second partial image based on a center point of the region corresponding to the plurality of first key points and a first adjustment parameter, the first partial image being an image corresponding to the region corresponding to the plurality of first key points, and the second partial image being an image other than the first partial image in the target region.

13. The electronic device according to claim 12, wherein the one or more processors are configured to perform:
adjusting a shape of the first partial image based on the center point of the region corresponding to the plurality of first key points and the first adjustment parameter; and
dispersing the pixel points in the second partial image to acquire the second image.

14. The electronic device according to claim 13, wherein the one or more processors are configured to perform:
determining a first movement direction in response to the first partial image being zoomed out, wherein the first movement direction is a direction approaching the center point;
determining a first movement distance based on the first adjustment parameter, and
acquiring the second image by moving the pixel points in the second partial image by the first movement distance in the first movement direction.

15. The electronic device according to claim 13, wherein the one or more processors are configured to perform:
determining a second movement direction in response to the first partial image being zoomed in, wherein the second movement direction is a direction going away from the center point;
determining a second movement distance based on the first adjustment parameter, and
acquiring the second image by moving the pixel points in the second partial image by the second movement distance in the second movement direction.

16. The electronic device according to claim 12, wherein the one or more processors are configured to perform:
determining a target center point, wherein the target center point is acquired based on the plurality of first key points;
determining that, for each first key point, a second key point, the first key point, and the target center point are on one straight line, and a first distance is greater than a second distance, the first distance being a distance between the second key point and the target center point, and the second distance being a distance between the first key point and the target center point; and
determining the target region based on a plurality of second key points.

17. The electronic device according to claim 16, wherein the one or more processors are configured to perform at least one of:
determining a center point of the plurality of first key points as the target center point; and
determining a center point of a part of the first key points as the target center point, wherein the part of first key points are disposed in a center zone of the region corresponding to the plurality of first key points.

18. The electronic device according to claim 12, wherein the one or more processors are configured to perform:
determining a plurality of third key points in a third image, wherein the plurality of third key points are key points of the target part, and the third image is a previous frame of the first image;
determining a plurality of fourth key points in the first image, wherein the plurality of fourth key points are key points of the target part, and the fourth key points are determined by a key point determination model; and
determining the plurality of first key points based on the plurality of third key points and the plurality of fourth key points.

19. The electronic device according to claim 18, wherein the one or more processors are configured to perform:
determining, for each fourth key point, a first target key point in the plurality of third key points, wherein the first target key point and the fourth key point have an equal pixel value;
determining an average position of a first position and a second position, wherein the first position is a position of the first target key point, and the second position is a position of the fourth key point; and
acquiring the first key point by rendering the pixel value of the fourth key point to the average position.

20. A non-transitory computer-readable storage medium storing instructions therein, wherein the instructions, when executed by a processor of an electronic device, cause the electronic device to perform:
determining a plurality of first key points in a first image, wherein the plurality of first key points are key points of a target part;
determining a target region of the first image by expanding a region corresponding to the plurality of first key points; and
acquiring a second image by adjusting positions of pixel points in a first partial image and a second partial image based on a center point of the region corresponding to the plurality of first key points and a first adjustment parameter, the first partial image being an image corresponding to the region corresponding to the plurality of first key points, and the second partial image being an image other than the first partial image in the target region.
